(19) United States
(12) Patent Application Publication
(10) Pub. No.: US 2012/0299984 A1
(43) Pub. Date: Nov. 29, 2012

(54) DISPLAY DEVICE AND DISPLAYING METHOD

(75) Inventors: Yuji Nakahata, Kanagawa (JP); Makoto Nakagawa, Tokyo (JP)

(73) Assignee: SONY CORPORATION, Tokyo (JP)

(21) Appl. No.: 13/465,357

(22) Filed: May 7, 2012

(30) Foreign Application Priority Data
May 26, 2011 (JP) 2011-118189

(51) Int. Cl. G09G 5/10

(52) U.S. Cl. 345/691

(57) ABSTRACT

A display device includes: a display section; a barrier section including a plurality of light barriers, wherein each of the light barriers is switched to be opened or closed; and a shutter control section switching each of a left-eye shutter and a right-eye shutter of one or more shutter glasses to be opened or closed, in synchronization with timing of opening or closing of the light barriers.

### BACKGROUND

The present disclosure relates to a display device displaying pictures, and a displaying method used for the display device.

Recently, display systems that achieve stereoscopic display have been noticed. One of the display systems includes shutter glasses (for example, Japanese Unexamined Patent Application Publication No. H09-138384). In such a display system, left-eye images and right-eye images with parallaxes therebetween are alternately displayed on a display device in a time-divisional manner, and a left-eye shutter and a right-eye shutter of the shutter glasses are controlled to be opened or closed in a switchable manner in synchronization with switching of the images. Such switching operation is repeated, thereby a viewer recognizes a deep stereoscopic image through viewing a picture including these sequential images.

### SUMMARY

In the display system that achieves stereoscopic display, mixing of a left-eye image and a right-eye image, so-called crosstalk, may typically occur. In such a case, image quality is degraded. Hence, a reduction in crosstalk is desired for such a display system.

It is desirable to provide a display device enabling a reduction in crosstalk, and a displaying method used for the display device.

According to an embodiment of the disclosure, there is provided a display device including: a display section; a barrier section including a plurality of light barriers, wherein each of the light barriers is switched to be opened or closed; and a shutter control section switching each of a left-eye shutter and a right-eye shutter of one or more shutter glasses to be opened or closed, in synchronization with timing of opening or closing of the light barriers.

According to an embodiment of the disclosure, there is provided a displaying method including: displaying a picture; switching a plurality of light barriers to be opened or closed; and switching each of a left-eye shutter and a right-eye shutter of one or more shutter glasses to be opened or closed, in synchronization with timing of opening or closing of the light barriers.

In the display device and the displaying method according to the embodiments of the disclosure, a picture that appears on the display section is seen by a viewer through the left-eye shutter and the right-eye shutter of the shutter glasses. The picture is seen by the viewer through the light barriers being opened.

According to the display device and the displaying method according to the embodiments of the disclosure, both the light barriers and the shutter glasses are used. Hence, it is possible to reduce crosstalk.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating an exemplary configuration of a display system according to an embodiment of the disclosure.

FIG. 2 is a block diagram illustrating an exemplary configuration of a display drive section shown in FIG. 1.

FIGS. 3A and 3B are explanatory views illustrating an exemplary configuration of a display section shown in FIG. 1.

FIGS. 4A and 4B are explanatory views illustrating an exemplary configuration of a barrier section shown in FIG. 1.

FIG. 5 is a plan view illustrating a correspondence between the barrier section and the display section shown in FIG. 1.

FIGS. 6A and 6B are schematic views illustrating an exemplary operation of the display system shown in FIG. 1.

FIG. 7 is a timing chart illustrating an exemplary operation of a display system according to a first embodiment.

FIG. 8 is another timing chart illustrating the exemplary operation of the display system according to the first embodiment.

FIG. 9 is a block diagram illustrating an exemplary configuration of a display system according to a comparative example.

FIG. 10 is a timing chart illustrating an exemplary operation of the display system shown in FIG. 9.

FIG. 11 is a timing chart illustrating an exemplary operation of a display system according to a modification of the first embodiment.

FIG. 12 is a timing chart illustrating an exemplary operation of a display system according to another modification of the first embodiment.

FIG. 13 is a timing chart illustrating an exemplary operation of a display system according to still another modification of the first embodiment.

FIG. 14 is a timing chart illustrating an exemplary operation of a display system according to a second embodiment.

FIG. 15 is another timing chart illustrating the exemplary operation of the display system according to the second embodiment.

FIG. 16 is a timing chart illustrating an exemplary operation of a display system according to a modification of the second embodiment.

FIG. 17 is a block diagram illustrating an exemplary configuration of a display system according to another modification of the second embodiment.

FIG. 18 is a timing chart illustrating an exemplary operation of the display system shown in FIG. 17.

FIG. 19 is a block diagram illustrating an exemplary configuration of a display system according to a third embodiment.

FIGS. 20A and 20B are schematic views illustrating an exemplary operation of the display system shown in FIG. 19.

FIG. 21 is a timing chart illustrating an exemplary operation of the display system shown in FIG. 19.

FIG. 22 is a plan view illustrating an exemplary configuration of a barrier section according to a modification.

FIG. 23 is a timing chart illustrating an exemplary operation of a display system according to a modification.

FIG. 24 is a block diagram illustrating an exemplary configuration of a display system according to another modification.

### DETAILED DESCRIPTION

Embodiments of the disclosure are now described in detail with reference to the accompanying drawings. It is to be noted that description is made in the following order.

1. First Embodiment

2. Second Embodiment

3. Third Embodiment

### 1. First Embodiment

### Exemplary Configuration

### (Exemplary Overall Configuration)

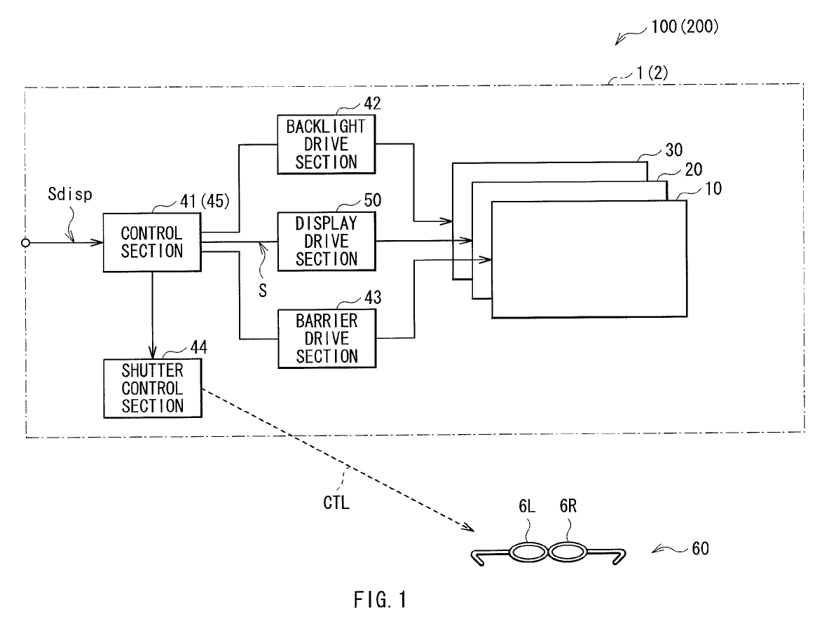

FIG. 1 illustrates an exemplary configuration of a display system according to a first embodiment. A display system 100 is a display system performing stereoscopic display. Since a display device and a displaying method according to the embodiments of the disclosure are embodied by the first embodiment, they are described together. The display system 100 includes a display device 1 and shutter glasses 60.

As shown in FIG. 1, the display device 1 includes a control section 41, a backlight drive section 42, a backlight 30, a display drive section 50, a display section 20, a barrier drive section 43, a barrier section 10, and a shutter control section 44.

The control section 41 is a circuit that supplies a control signal to each of the backlight drive section 42, the display drive section 50, the barrier drive section 43, and the shutter control section 44 based on an externally-supplied picture signal Sdisp, and controls the backlight drive section 42, the display drive section 50, the barrier drive section 43, and the shutter control section 44 to operate in synchronization with one another. In detail, the control section 41 supplies a backlight control signal to the backlight drive section 42, supplies a picture signal S based on the picture signal Sdisp to the display drive section 50, supplies a barrier control signal to the barrier drive section 43, and supplies a control signal to the shutter control section 44. The picture signal Sdisp includes image information of a left-eye image PL and of a right-eye image PR described later.

The backlight drive section 42 drives the backlight 30 based on the backlight control signal supplied from the control section 41. The backlight 30 has a function of outputting surface-emitted light to the display section 20. The backlight 30 is configured of light emitting diodes (LEDs) or a cold cathode fluorescent lamp (CCFL), for example.

The display drive section 50 drives the display section 20 based on the picture signal S supplied from the control section 41. The display section 20, which is a liquid crystal display section herein, drives a liquid crystal display element to modulate the light emitted from the backlight 30 to perform image display.

The barrier drive section 43 drives the barrier section 10 based on the barrier control signal supplied from the control section 41. The barrier section 10 transmits (opened state) or blocks (closed state) light emitted from the backlight 30 and transmitted by the display section 20.

As shown in FIG. 1, the display device 1 includes the backlight 30, the display section 20, and the barrier section 10 disposed in this order. Specifically, light is emitted from the backlight 30 and received by a viewer through the display section 20 and the barrier section 10.

The shutter control section 44 generates a shutter control signal CTL based on the control signal supplied from the control section 41, and supplies the shutter control signal CTL to the shutter glasses 60 through wireless communication. Although the shutter control section 44 supplies the shutter control signal CTL to the shutter glasses through wireless communication herein, this is not limitative. For example, the shutter control section 44 may supply the shutter control signal CTL through wire communication.

The shutter glasses 60 are a glasses-type shutter device, and enables stereoscopy through wearing of the shutter glasses 60 by a viewer (not shown). The shutter glasses 60 have a left-eye shutter 6L and a right-eye shutter 6R. The left-eye shutter 6L and the right-eye shutter 6R are each configured of, for example, a liquid crystal shutter. A light-transmitting state (opened state) and a light-blocking state (closed state) of each of the left-eye shutter 6L and the right-eye shutter 6R are controlled by the shutter control signal CTL supplied from the shutter control section 44.

### (Display Drive Section 50 and Display Section 20)

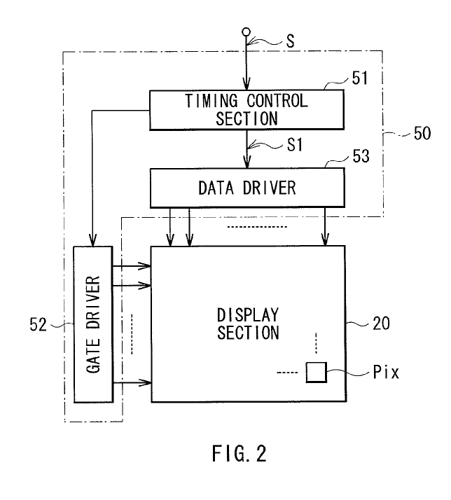

FIG. 2 illustrates an exemplary configuration of a display drive section 50. The display drive section 50 includes a timing control section 51, a gate driver 52, and a data driver 53. The timing control section 51 controls drive timing of each of the gate driver 52 and the data driver 53, and supplies the picture signal S supplied from the control section 41 to the data driver 53 as a picture signal S1. The gate driver 52 sequentially selects pixels Pix (described later) in the display section 20 for each row in accordance with timing control by the timing control section 51 for line-sequential scan. The data driver 53 supplies a pixel signal based on the picture signal S1 to each of the pixels Pix in the display section 20.

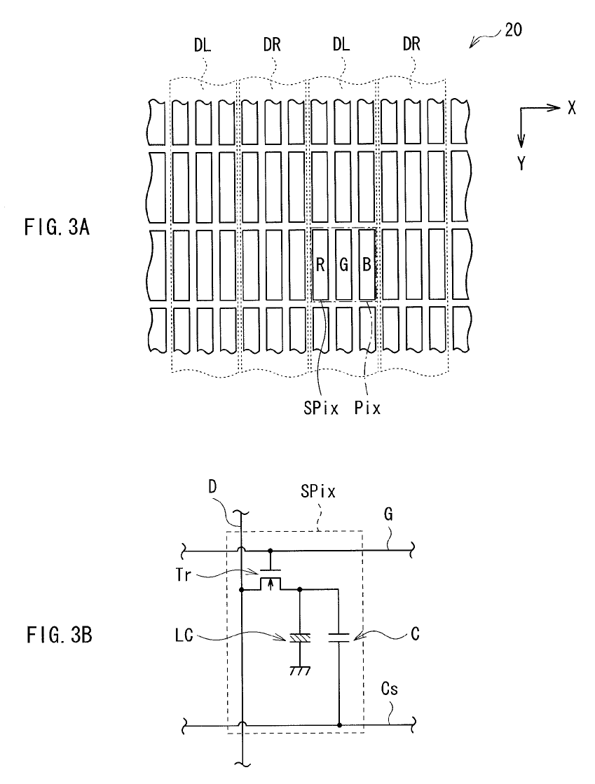

FIGS. 3A and 3B illustrate an exemplary configuration of the display section 20, where FIG. 3A shows an arrangement of the pixels Pix, and FIG. 3B shows an example of a circuit diagram of a sub-pixel Spix in a pixel Pix.

The display section 20 has a plurality of pixels Pix provided in a matrix. Each pixel Pix includes three sub-pixels Spix corresponding to three colors of red (R), green (G), and blue (B).

As shown in FIG. 3A, the display section 20 has a plurality of regions DL and DR extending in a vertical direction Y in a display screen. The plurality of regions DL and DR are alternately disposed in a horizontal direction X. The display section 20 displays left-eye images PL by a plurality of pixels Pix in the regions DL, while the display section 20 displays right-eye images PR by a plurality of pixels Pix in the regions DR, as described later.

As shown in FIG. 3B, the sub-pixel Spix includes a thin film transistor (TFT) element Tr, a liquid crystal element LC, and a holding capacitance element C. The TFT element Tr, which is composed of, for example, a metal oxide semiconductor-field effect transistor (MOS-FET), has a gate connected to a gate line G, a source connected to a data line D, and a drain connected to a first end of the liquid crystal element LC and to a first end of the holding capacitance element C. The liquid crystal element LC has the first end connected to the drain of the TFT element Tr, and a second end being grounded. The holding capacitance element C has the first end connected to the drain of the TFT element Tr, and a second end connected to a holding capacitance line Cs. The gate line G is connected to the gate driver 52, and the data line D is connected to the data driver 53.

### (Barrier Section 10 and Barrier Drive Section 43)

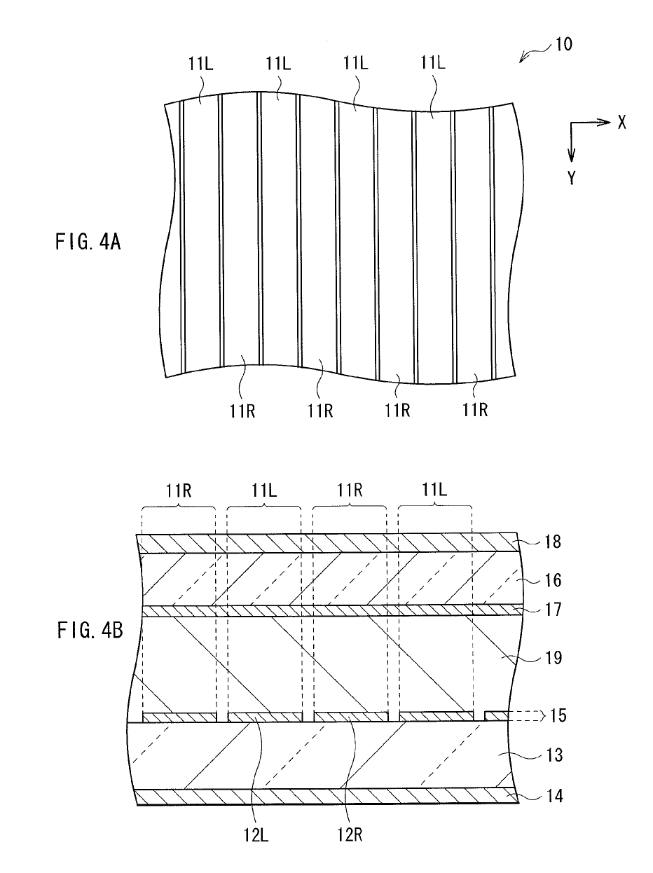

FIGS. 4A and 4B illustrate an exemplary configuration of the barrier section 10, where FIG. 4A shows a plan view of the barrier section 10, and FIG. 4B shows a sectional configuration along a IV-IV arrow direction of the barrier section 10 shown in FIG. 4A. Here, the barrier section 10 performs normally black operation. Specifically, the barrier section 10 blocks light while being not driven.

The barrier section 10 includes liquid crystal barriers 11L and 11R that transmit or block light. The liquid crystal barriers 11L and 11R are provided to extend in the vertical direction Y, and are alternately disposed in the horizontal direction X. The liquid crystal barriers 11L and 11R operate to be time-divisionally switched between a light-transmitting state (opened state) and a light-blocking state (closed state), namely, are time-divisionally opened or closed.

As shown in FIG. 4B, the barrier section 10 includes a liquid crystal layer 19 between transparent substrates 13 and 16 including, for example, glass. Here, the transparent substrate 13 is disposed on a light input side, and the transparent substrate 16 is disposed on a light output side. Transparent electrode layers 15 and 17 including, for example, indium tin oxide (ITO) are provided on respective surfaces close to the liquid crystal layer 19 of the transparent substrates 13 and 16. Each of the transparent electrode layers 15 and 17 has an undepicted alignment film on its surface close to the liquid crystal layer 19. The liquid crystal layer 19 includes, for example, a vertical alignment (VA) mode of liquid crystal. Polarizing plates 14 and 18 are attached to the transparent substrate 13 on its light input side and the transparent substrate 16 on its light output side, respectively.

The transparent electrode layer 15 includes a plurality of transparent electrodes 12L and 12R. The transparent electrode layer 17 is provided as an electrode common to the transparent electrodes 12L and 12R. Here, 0 V is applied to the transparent electrode layer 17. The transparent electrodes 12L of the transparent electrode layer 15, the liquid crystal layer 19, and portions corresponding to the transparent electrodes 12L of the transparent electrode layer 17 define the liquid crystal barriers 11L. Similarly, the transparent electrodes 12R of the transparent electrode layer 15, the liquid crystal layer 19, and portions corresponding to the transparent electrodes 12R of the transparent electrode layer 17 define the liquid crystal barriers 11R. According to such a configuration, in the barrier section 10, a voltage is selectively applied to the transparent electrodes 12L and 12R, and the liquid crystal of the liquid crystal layer 19 is aligned depending on the voltage, so that the liquid crystal barriers 11L and 11R are separately opened or closed.

It is to be noted that although the barrier section performs normally black operation herein, this is not limitative. For example, the barrier section 10 may perform normally white operation instead.

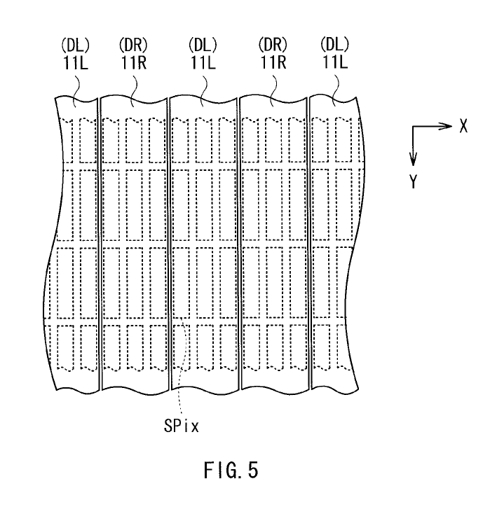

FIG. 5 illustrates a correspondence between the liquid crystal barriers 11L and 11R of the barrier section 10 and an arrangement of the pixels Pix of the display section 20. As shown in FIG. 5, the liquid crystal barriers 11L are disposed in correspondence to the regions DL of the display section 20. Similarly, the liquid crystal barriers 11R are disposed in correspondence to the regions DR of the display section 20. Specifically, the display section 20 displays the left-eye images PL in the regions DL corresponding to the liquid crystal barriers 11L, and displays the right-eye images PR in the regions DR corresponding to the liquid crystal barriers 11R.

The regions DL and DR correspond to one specific example of “sub-regions” in one embodiment of the disclosure.

### [Operation and Functions]

The operation and functions of the display system 100 of the first embodiment are now described.

### (Outline of General Operation)

An outline of general operation of the display system 100 is now described with reference to FIG. 1. The control section 41 supplies the control signal to each of the backlight drive section 42, the display drive section 50, the barrier drive section 43, and the shutter control section 44 based on the externally-supplied picture signal Sdisp, and controls the backlight drive section 42, the display drive section 50, the barrier drive section 43, and the shutter control section 44 to operate in synchronization with one another. The backlight drive section 42 drives the backlight 30. The backlight 30 outputs surface-emitted light to the display section 20. The display drive section 50 drives the display section 20. The display section 20 modulates the light emitted from the backlight 30 for image display. The barrier drive section 43 drives the barrier section 10. The barrier section 10 transmits (opened state) or blocks (closed state) the light emitted from the backlight 30 and transmitted by the display section 20. The shutter control section 44 generates the shutter control signal CTL, and supplies the shutter control signal CTL to the shutter glasses 60. The left-eye shutter 6L and the right-eye shutter 6R of the shutter glasses 60 are each opened or closed based on the shutter control signal CTL.

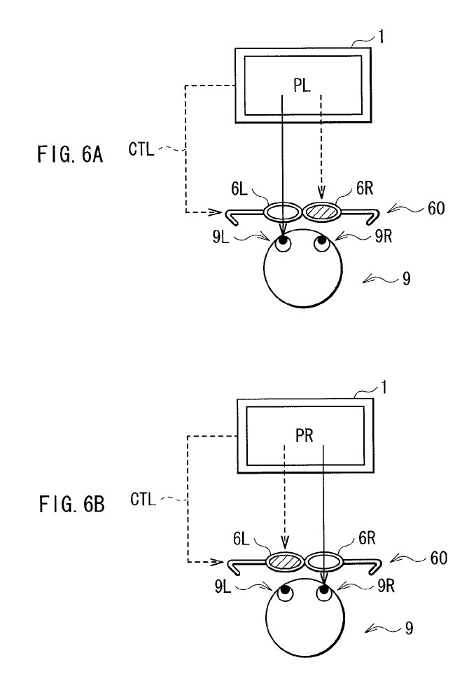

FIGS. 6A and 6B schematically illustrate general operation of the display system 100. FIG. 6A shows an operation during display of a left-eye image PL. FIG. 6B shows an operation during display of a right-eye image PR. As shown in FIG. 6A, while the display device 1 displays the left-eye image PL, the left-eye shutter 6L of the shutter glasses 60 is opened, and the right-eye shutter 6R is closed. During this operation, a viewer 9 sees the left-eye image PL by a left eye 9L. On the other hand, as shown in FIG. 6B, while the display device 1 displays the right-eye image PR, the left-eye shutter 6L of the shutter glasses 60 is closed, and the right-eye shutter 6R thereof is opened. During this operation, the viewer 9 sees the right-eye image PR by a right eye 9R. These operations are alternately repeated, so that the viewer 9 may recognize a deep stereoscopic picture through viewing a picture including such sequential images due to a parallax between the left-eye image PL and the right-eye image PR.

### (Detailed Operation)

The detailed operation of the display system 100 is now described.

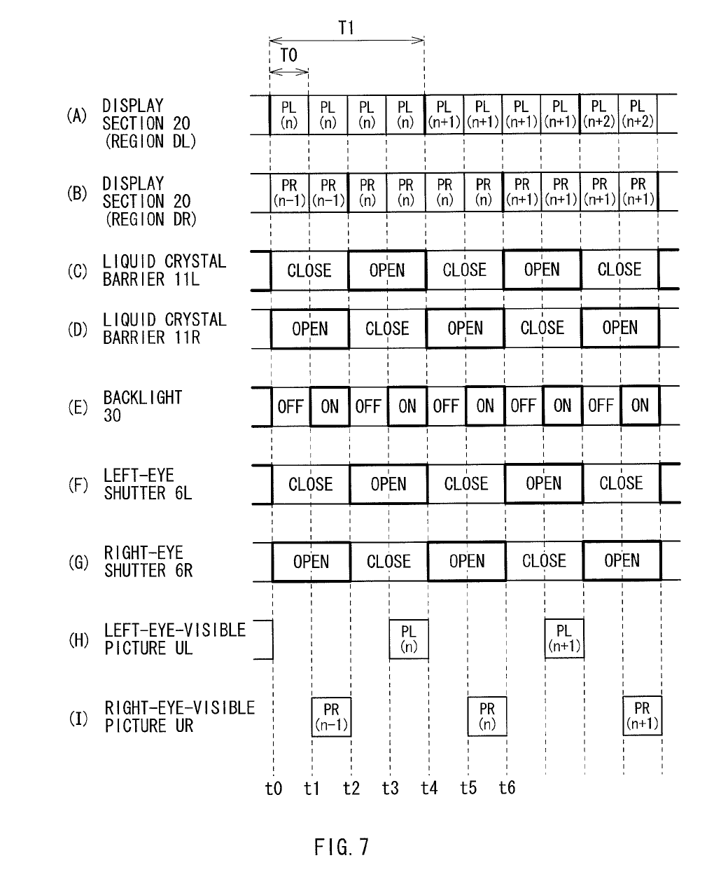

FIG. 7 illustrates an exemplary operation of the display system 100, where (A) and (B) show operations of the regions DL and DR of the display section 20, respectively, (C) and (D) show operations of the liquid crystal barriers 11L and 11R of the barrier section 10, respectively, (E) shows an operation of the backlight 30, (F) and (G) show operations of the left-eye shutter 6L and the right-eye shutter 6R of the shutter glasses 60, respectively, and (H) and (I) show a left-eye-visible picture UL and a right-eye-visible picture UR perceived by a viewer, respectively. In (A) and (B) of FIG. 7, a symbol PL indicates a state where the display section 20 displays the left-eye image PL, and a symbol PR indicates a state where the display section 20 displays the right-eye image PR. It is to be noted that, for example, an index “n” of PL(n) is added to identify a frame image for convenience of description.

In the display system 100, the liquid crystal barriers 11L and 11R are separately opened or closed, so that the display device 1 time-divisionally displays the left-eye images PL and the right-eye images PR. In addition, the left-eye shutter 6L and the right-eye shutter 6R of the shutter glasses 60 are opened or closed in synchronization with display of the left-eye images PL and the right-eye images PR, respectively, so that a viewer perceives the left-eye-visible picture UL through viewing sequential left-eye images PL, and perceives the right-eye-visible picture UR through viewing sequential right-eye images PR. This operation is now described in detail below.

In the display device 1, during a period of timing tO to timing t4, the display section 20 repeatedly displays the same left-eye image PL(n) on a region DL over a period (repetitive-display period T1) corresponding to four frame periods T0 ((A) of FIG. 7). For example, the repetitive-display period T1 is 16.7 msec (=1/60 Hz), and the frame period T0 is 4.2 msec (=T1/4). Specifically, the display device 1 is a so-called quadruple-speed, liquid crystal display device herein. During a period of timing t2 to timing t4, the liquid crystal barrier 11L is opened (light-transmitting state) ((C) of FIG. 7). It is to be noted that although the liquid crystal barrier 11L is opened from timing t2 in consideration of the response characteristic of the liquid crystal molecules in the liquid crystal barrier 11L herein, this is not limitative. If the response speed of the liquid crystal molecules is high, the liquid crystal barrier 11L may be opened from timing t3, for example. During a period of timing t3 to timing t4, the backlight 30 is on ((E) of FIG. 7). Consequently, the display device 1 displays the left-eye image PL(n) during the period of timing t3 to timing t4.

On the other hand, in the shutter glasses 60, the left-eye shutter 6L is opened (light-transmitting state) during the period of timing t2 to timing t4 ((F) of FIG. 7). It is to be noted that although the left-eye shutter 6L is opened from timing t2 in consideration of the response characteristic of the liquid crystal molecules of the left-eye shutter 6L herein as in the case of the liquid crystal barrier 11L, this is not limitative. If the response speed of the liquid crystal molecules is high, the left-eye shutter 6L may be opened from timing t3, for example. Consequently, a viewer sees the left-eye image PL(n) during the period of timing t3 to timing t4 ((H) of FIG. 7).

Similarly, in the display device 1, during a period of timing t2 to timing t6, the display section 20 repeatedly displays the same right-eye image PR(n) on a region DR over a period (repetitive-display period T1) corresponding to four frame periods T0 ((B) of FIG. 7). During a period of timing t4 to timing t6, the liquid crystal barrier 11R is opened (light-transmitting state), and during a period of timing t5 to timing t6, the backlight 30 is on ((D) and (E) of FIG. 7). Consequently, the display device 1 displays the right-eye image PR(n) during the period of timing t5 to timing t6. On the other hand, in the shutter glasses 60, the right-eye shutter 6R is opened (light-transmitting state) during the period of timing t4 to timing t6 ((G) of FIG. 7). Consequently, a viewer sees the right-eye image PR(n) during the period of timing t5 to timing t6 ((I) of FIG. 7).

The above operation is repeated, thereby the viewer perceives a left-eye-visible picture UL through viewing the sequential left-eye images PL ((H) of FIG. 7), and perceives a right-eye-visible picture UR through viewing the sequential right-eye images PR ((I) of FIG. 7), so that the viewer perceives a stereoscopic picture through viewing a picture appearing on the display system 100.

In the display system 100, the same left-eye image PL and the same right-eye image PR are each repeatedly displayed over the period (repetitive-display period T1) corresponding to the four frame periods T0, and the backlight 30 is lit so that a viewer sees each image in the last frame period T0. Consequently, for example, even if the liquid crystal element LC of the display section 20 has a slow response characteristic, the viewer sees the image after the response of the liquid crystal is saturated. This is now described in detail below.

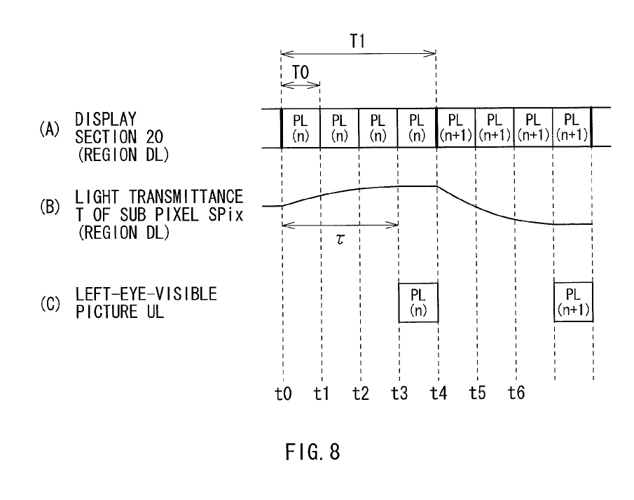

FIG. 8 illustrates a response characteristic of the liquid crystal element LC of the display section 20, where (A) shows an operation of the region DL of the display section 20, (B) shows the light transmittance T of a sub pixel SPix of the region DL, and (C) shows the left-eye-visible picture UL. Although description is made on the left-eye image PL herein, the same holds true for the right-eye image PR.

The display section 20 starts display of the left-eye image PL(n) at timing tO ((A) of FIG. 8). At that time, as shown in (B) of FIG. 8, in the sub pixel SPix of the display section 20, if the liquid crystal element LC has a slow response speed, the light transmittance T of the sub pixel SPix may exhibit a long response time T over a plurality of (herein, three) frame periods T0 before the light transmittance T is saturated. In the display system 100, however, the viewer sees the left-eye image PL(n) in the last frame period T0 (the period of timing t3 to timing t4) of the repetitive-display period T1. Therefore, the viewer sees the image after the response of the liquid crystal is saturated, thereby suppressing a degradation in image quality.

### Comparative Example

Functions of the display system of the first embodiment are now described in comparison with a comparative example.

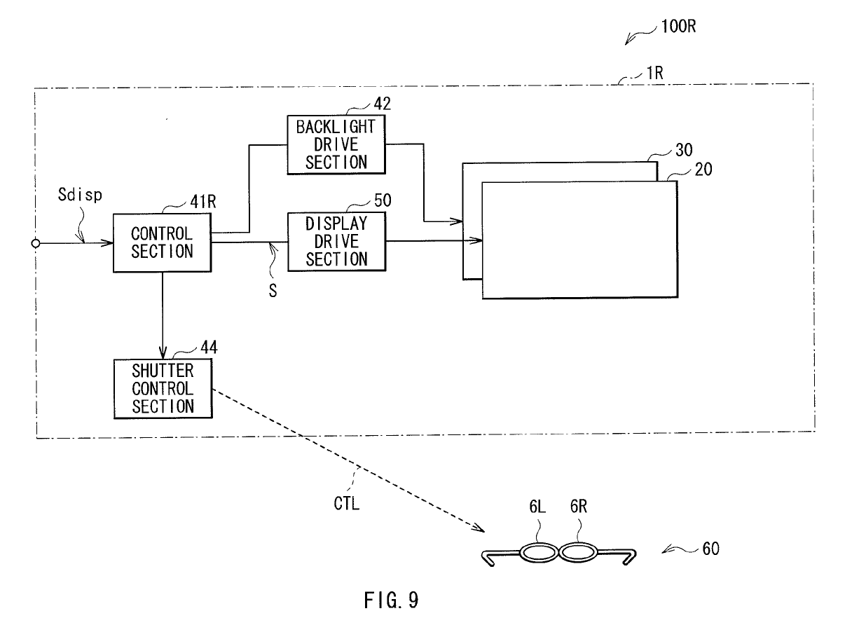

FIG. 9 illustrates an exemplary configuration of a display system 100R according to the comparative example. The display system 100R includes a display device 1R. The display device 1R is different from the display device 1 (FIG. 1) according to the embodiment in that the barrier section 10 is removed. The display device 1R time-divisionally displays left-eye images PL and right-eye images PR without a barrier section. Specifically, in the display device 1 according to the embodiment, the display section 20 displays the left-eye images PL and the right-eye images PR on the regions DL and DR, respectively, and the liquid crystal barriers 11L and 11R are separately opened or closed, thereby the left-eye images PL and the right-eye images PR are time-divisionally displayed. In contrast, the display device 1R according to the comparative example time-divisionally displays the left-eye images PL and the right-eye images PR on the entire display screen.

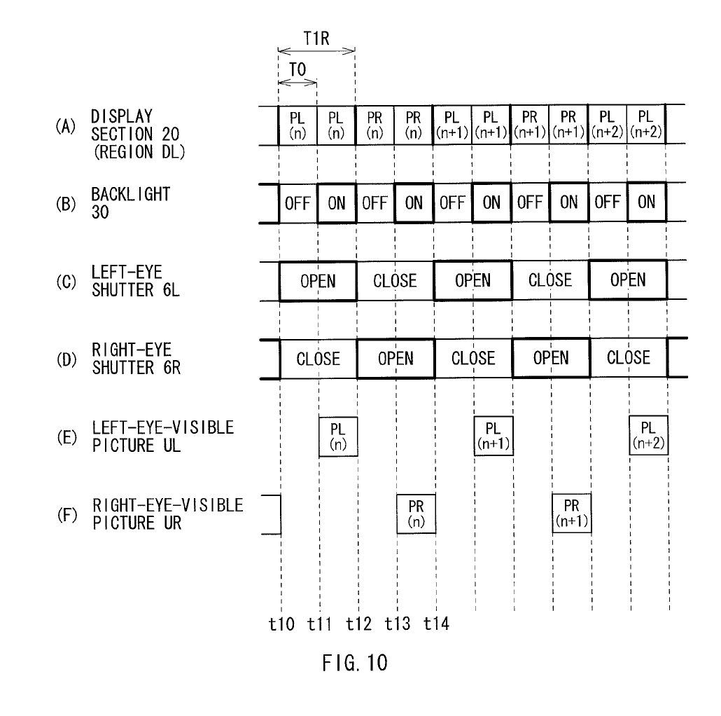

FIG. 10 illustrates an exemplary operation of the display system 100R, where (A) shows an operation of a display section 20, (B) shows an operation of a backlight 30, (C) and (D) show operations of a left-eye shutter 6L and a right-eye shutter 6R of shutter glasses 60, and (E) and (F) show a left-eye-visible picture UL and a right-eye-visible picture UR perceived by a viewer, respectively.

In the display device 1R, during a period of timing t10 to timing t12, the display section 20 repeatedly displays the same left-eye image PL(n) on the entire display screen over a period (repetitive-display period T1R) corresponding to two frame periods T0 ((A) of FIG. 10). For example, the repetitive-display period T1R is 8.3 msec. During a period of timing t11 to timing t12, the backlight 30 is on ((B) of FIG. 10). Consequently, the display device 1R displays the left-eye image PL(n) during the period of timing t11 to timing t12. On the other hand, in the shutter glasses 60, the left-eye shutter 6L is opened (light-transmitting state) during the period of timing t10 to timing t12 ((C) of FIG. 10). Consequently, a viewer sees the left-eye image PL(n) during the period of timing t11 to timing t12 ((E) of FIG. 10).

In the display device 1R, during a period of timing t12 to timing t14, the display section 20 then repeatedly displays the same right-eye image PR(n) on the entire display screen over a period (repetitive-display period T1R) corresponding to two frame periods T0 ((A) of FIG. 10). During a period of timing t13 to timing t14, the backlight 30 is on ((B) of FIG. 10). Consequently, the display device 1R displays the right-eye image PR(n) during the period of timing t13 to timing t14. On the other hand, in the shutter glasses 60, the right-eye shutter 6R is opened (light-transmitting state) during the period of timing t13 to timing t14 ((D) of FIG. 10). Consequently, a viewer sees the right-eye image PR(n) during the period of timing t13 to timing t14 ((F) of FIG. 10).

In the display system 100R according to the comparative example, the same left-eye image PL and the same right-eye image PR are each repeatedly displayed over the period (repetitive-display period T1R) corresponding to two frame periods T0, and the backlight 30 is lit so that a viewer sees the images in the second frame period T0. Specifically, in the display system 100R according to the comparative example, time from the beginning of image display to image viewing by a viewer is shorter than that in the display system 100 according to the embodiment. Thus, for example, if the liquid crystal element LC of the display section 20 has a slow response characteristic, the viewer sees an image before the response of the liquid crystal element LC is saturated. This results in display of an image in a transient state before image display is stabilized, leading to a degradation in image quality. In addition, in the display system 100R, since the display section 20 alternately displays the left-eye images PL and the right-eye images PR, mixing of the left-eye image PL and the right-eye image PR, so-called crosstalk, may occur. In detail, for example, if a left-eye image PL is displayed at timing t10, and if a next right-eye image PR is displayed at timing t12 before response of the liquid crystal element LC is saturated, a liquid crystal element LC displaying the right-eye image PR may be influenced by a liquid crystal element LC that has displayed the just prior left-eye image PL. The crosstalk occurs in this way, leading to a further degradation in image quality.

In contrast, in the display system 100 according to the embodiment, the barrier section 10 is provided, and the left-eye images PL are displayed on the regions DL corresponding to the liquid crystal barriers 11L, and the right-eye images PR are displayed on the regions DR corresponding to the liquid crystal barriers 11R. Specifically, the left-eye images PL and the right-eye images PR are displayed on the different regions DL and DR, thereby reducing the crosstalk due to the response characteristic of the liquid crystal element LC of the display section 20. Furthermore, the period during which each of the same left-eye image PL and the same right-eye image PR is repeatedly displayed, or the repetitive-display period T1R, is prolonged, and thus the time from the beginning of image display to image viewing by a viewer is prolonged. As a result, the viewer sees the image after the response of the liquid crystal is saturated, thereby suppressing a degradation in image quality.

It is to be noted that in the display system 100, the left-eye images PL and the right-eye images PR are displayed on the different regions DL and DR of the display section 20, respectively. Specifically, the number of pixels of each of the left-eye image PL and the right-eye image PR in the horizontal direction X is approximately half the number of pixels in the horizontal direction X over the entire display screen of the display section 20. This may result in a reduction in resolution in the horizontal direction X of a display image. Hence, the display system 100 may be typically used for, but not necessarily limited to, applications that are not sensitive to such a reduction in resolution. In addition, a display panel having a high resolution, which has been recently developed, may be effectively used to suppress such a degradation in image quality due to the reduction in resolution. In detail, there has been developed a display panel having a high resolution four times as high as that of a display panel (1920 pixels*1080 pixels) for full high definition (HD) display, so-called 4k2k display panel (3840 pixels*2160 pixels), which may be preferably (but not strictly necessary to be) used for the display system 100 to enable each of the left-eye images PL and the right-eye images PR to be displayed at the resolution of HD.

### ADVANTAGES

As described above, in the first embodiment, the left-eye images and the right-eye images are displayed on the different regions of the display section, thereby reducing the crosstalk.

In addition, in the first embodiment, the period where each of the same left-eye image PL and the same right-eye image PR is repeatedly displayed is prolonged, thereby suppressing a degradation in image quality.

### [Modification 1-1]

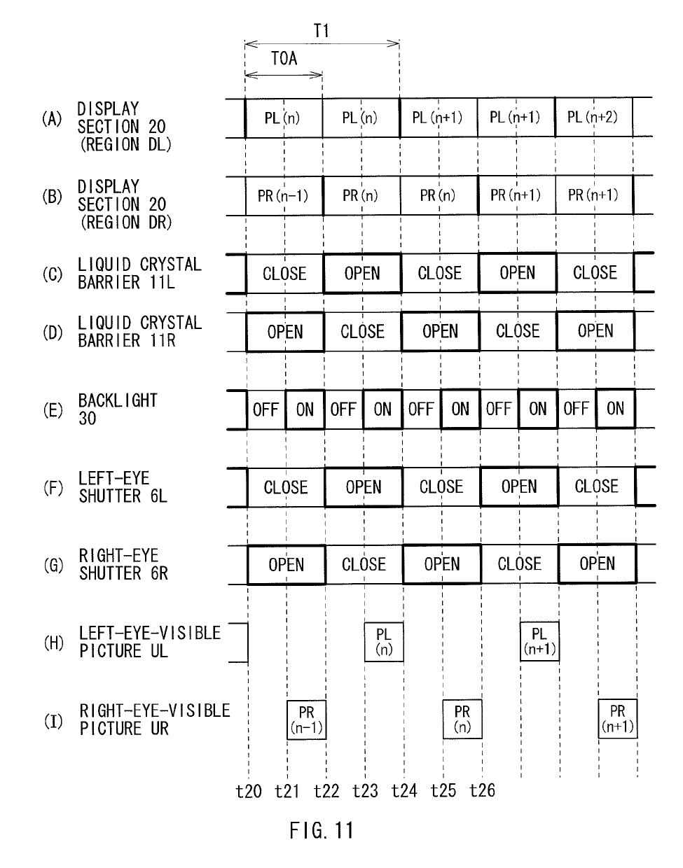

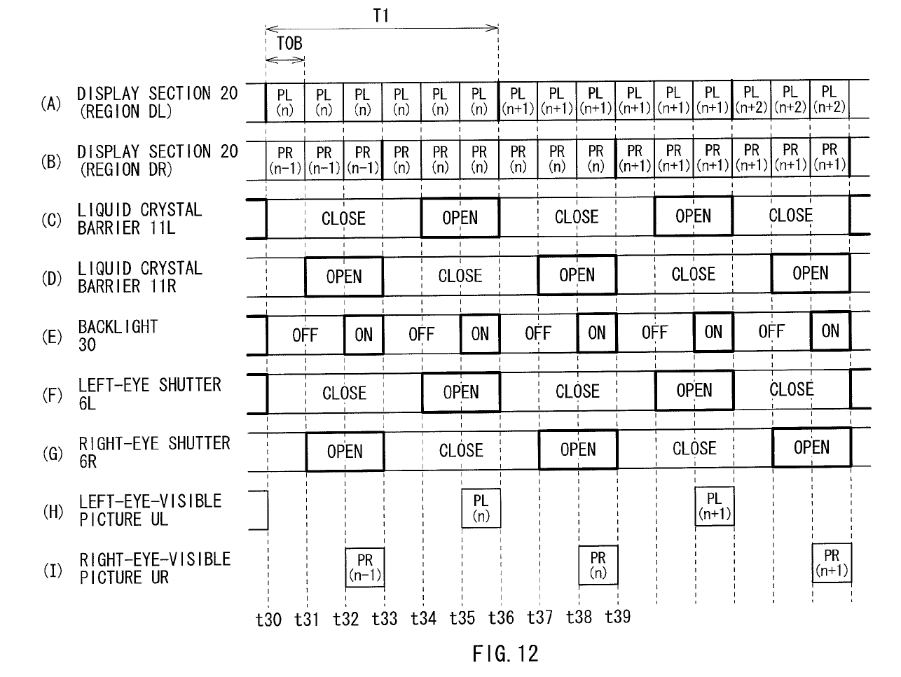

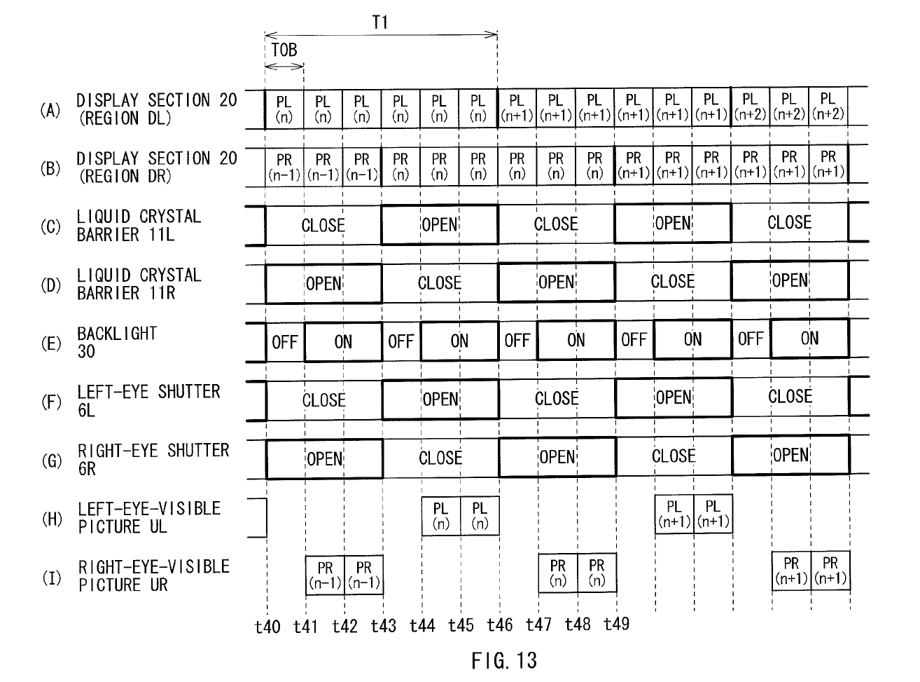

While the display device 1 is a quadruple-speed liquid crystal display device in the first embodiment, this is not limitative. For example, as shown in FIG. 11, the display device 1 may be a double-speed display device. Alternatively, for example, as shown in FIG. 12, the display device 1 may be a 6× display device. In the display system having the double-speed display device as shown in FIG. 11, the frame period TOA is, for example, 8.3 msec (=1/2/60 Hz), and the left-eye images PL and the right-eye images PR are each repeatedly displayed two times in the repetitive-display period T1, for example, 16.7 msec (=1/60 Hz). In the display system having the 6× display device as shown in FIG. 12, the frame period TOB is 2.8 msec (=1/6/60 Hz), and the left-eye images PL and the right-eye images PR are each repeatedly displayed six times in the repetitive-display period T1. It is to be noted that although the backlight 30 is lit in the last frame period TOB of the six frame periods TOB in the repetitive-display period T1 in FIG. 12, this is not limitative. For example, as shown in FIG. 13, the backlight 30 may be lit in the last two frame periods TOB of the six frame periods TOB in the repetitive-display period T1. In each case, the advantages as in the display system 100 according to the first embodiment are also provided.

### 2. Second Embodiment

A display system 200 according to a second embodiment is now described. In the second embodiment, black images are displayed together with left-eye images PL and right-eye images PR. Specifically, according to the second embodiment, the display system 200 includes a display device 2 including a control section 45, shown in FIG. 1, which generates black images. Other configurations are the same as those in the first embodiment shown in FIG. 1. It is to be noted that substantially the same components as those of the display system 100 according to the first embodiment are designated by the same numerals, and description of them is appropriately omitted.

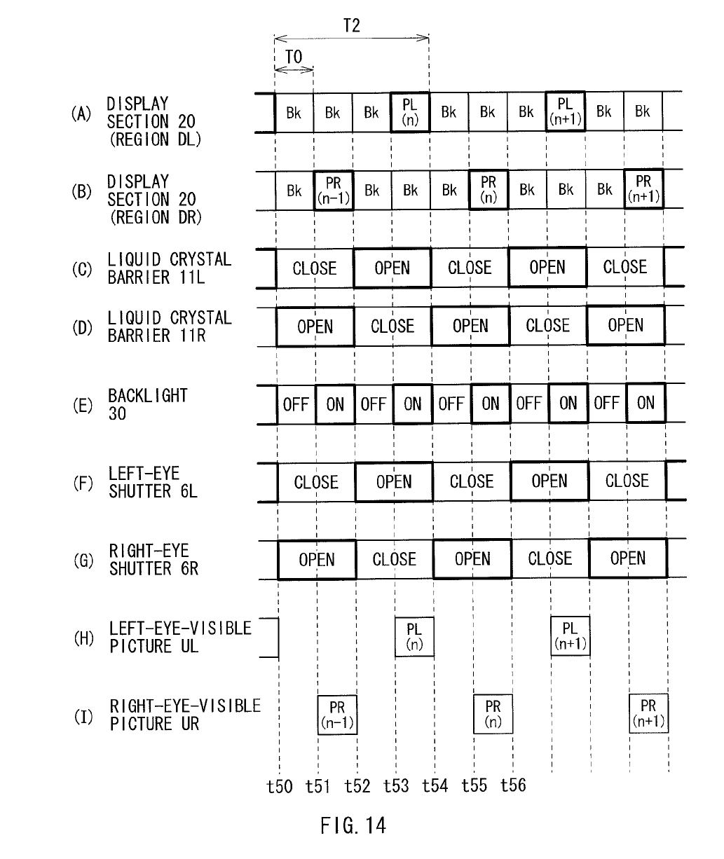

FIG. 14 illustrates an exemplary operation of the display system 200, where (A) and (B) show operations of regions DL and DR of a display section 20, respectively, (C) and (D) show operations of liquid crystal barriers 11L and 11R of a barrier section 10, respectively, (E) shows an operation of a backlight 30, (F) and (G) show operations of a left-eye shutter 6L and a right-eye shutter 6R of shutter glasses 60, respectively, and (H) and (I) show a left-eye-visible picture UL and a right-eye-visible picture UR perceived by a viewer, respectively. In (A) and (B) of FIG. 14, a symbol Bk indicates a state where the display section 20 displays a black image.

In the display device 2, during a period of timing t50 to timing t53, the display section 20 repeatedly displays a black image generated by the control section 45 on a region DL over a period corresponding to three frame periods T0, and during a subsequent period of timing t53 to timing t54, the display section 20 displays a left-eye image PL(n) on the region DL ((A) of FIG. 14). During a period of timing t52 to timing t54, the liquid crystal barrier 11L is opened (light-transmitting state), and during a period of timing t53 to timing t54, the backlight 30 is on ((C) and (E) of FIG. 14). Consequently, the display device 2 displays the left-eye image PL(n) during the period of timing t53 to timing t54. On the other hand, in the shutter glasses 60, the left-eye shutter 6L is opened (light-transmitting state) during the period of timing t52 to timing t54 ((F) of FIG. 14). Consequently, a viewer sees the left-eye image PL(n) during the period of timing t53 to timing t54 ((H) of FIG. 14).

Similarly, in the display device 2, during a period of timing t52 to timing t55, the display section 20 repeatedly displays the black image generated by the control section 45 on a region DR over a period corresponding to three frame periods T0, and during a subsequent period of timing t55 to timing t56, the display section 20 displays a right-eye image PR(n) on the region DR ((B) of FIG. 14). During a period of timing t54 to timing t56, the liquid crystal barrier 11R is opened (light-transmitting state), and during a period of timing t53 to timing t54, the backlight 30 is on ((D) and (E) of FIG. 14). Consequently, the display device 2 displays the right-eye image PR(n) during the period of timing t55 to timing t56. On the other hand, in the shutter glasses 60, the right-eye shutter 6R is opened (light-transmitting state) during the period of timing t54 to timing t56 ((G) of FIG. 14). Consequently, a viewer sees the right-eye image PR(n) during the period of timing t55 to timing t56 ((I) of FIG. 14).

The above operation is repeated, thereby the viewer perceives a left-eye-visible picture UL through viewing the sequential left-eye images PL ((H) of FIG. 14), and perceives a right-eye-visible picture UR through viewing the sequential right-eye images PR ((I) of FIG. 14), so that the viewer perceives a stereoscopic picture through viewing a picture appearing on the display system 200.

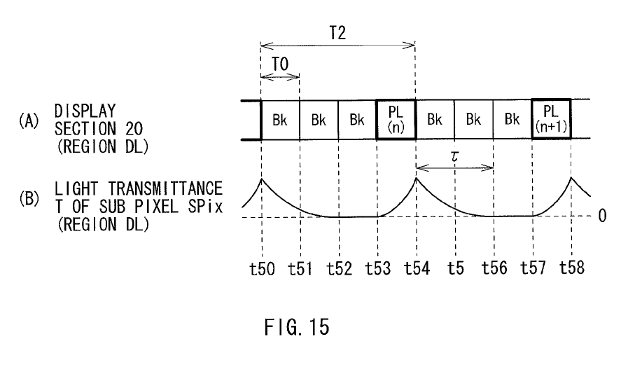

FIG. 15 illustrates a response characteristic of the liquid crystal element LC of the display section 20, where (A) shows an operation of a region DL of the display section 20, and (B) shows the light transmittance T of a sub pixel SPix in the region DL.

The display section 20 displays the left-eye image PL(n) during the period of timing t53 to timing t54, and displays the black image during a period of timing t54 to timing t57 ((A) of FIG. 15). During the period of timing t54 to timing t57, in the display section 20, response of a liquid crystal element LC of the sub pixel SPix is saturated after passing of response time T, leading to a low light-transmittance T. At timing t57, the light-transmittance T is extremely reduced and a next left-eye image PL(n+1) is displayed. Specifically, the light-transmittance T is typically extremely low at the start timing of image display. In this way, in the display system 200, image display is typically started under the same condition due to the black image display. As a result, a certain displayed-image less affects an image to be subsequently displayed, leading to suppression of a degradation in image quality.

As described above, in the second embodiment, the black images are displayed, thereby reducing a degradation in image quality. Other advantages are the same as in the first embodiment.

### [Modification 2-1]

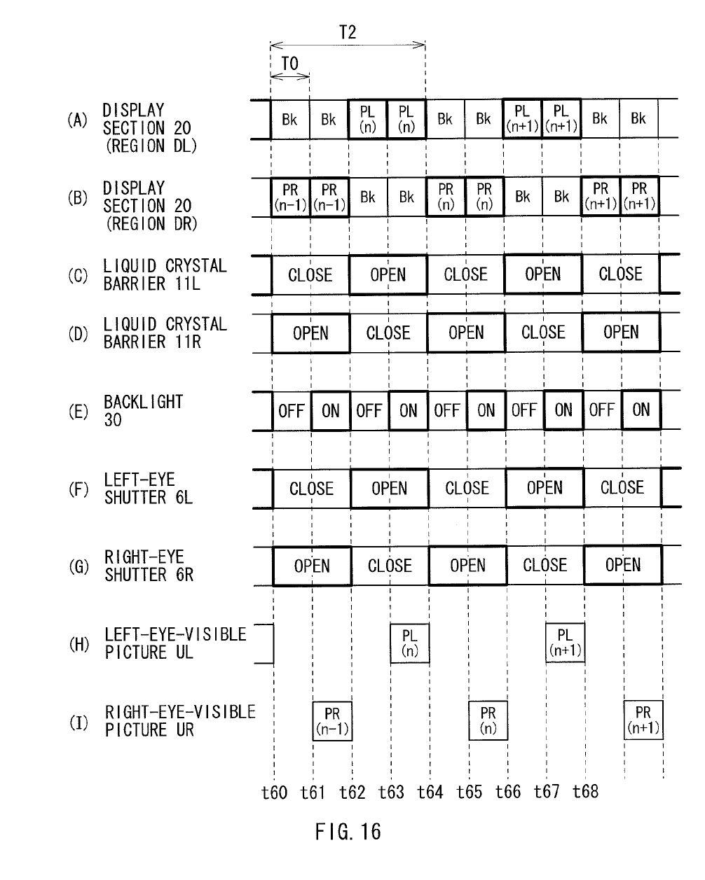

While the display section 20 displays the left-eye image PL or the right-eye image PR in one frame period T0 in the second embodiment, this is not limitative. For example, as shown in FIG. 16, the display section 20 may repeatedly display the image in two frame periods.

### [Modification 2-2]

While the display section 20 is configured of a liquid crystal display element in the second embodiment, this is not limitative. Alternatively, the display section 20 may be configured of a self-luminous display element. This is described further in detail below.

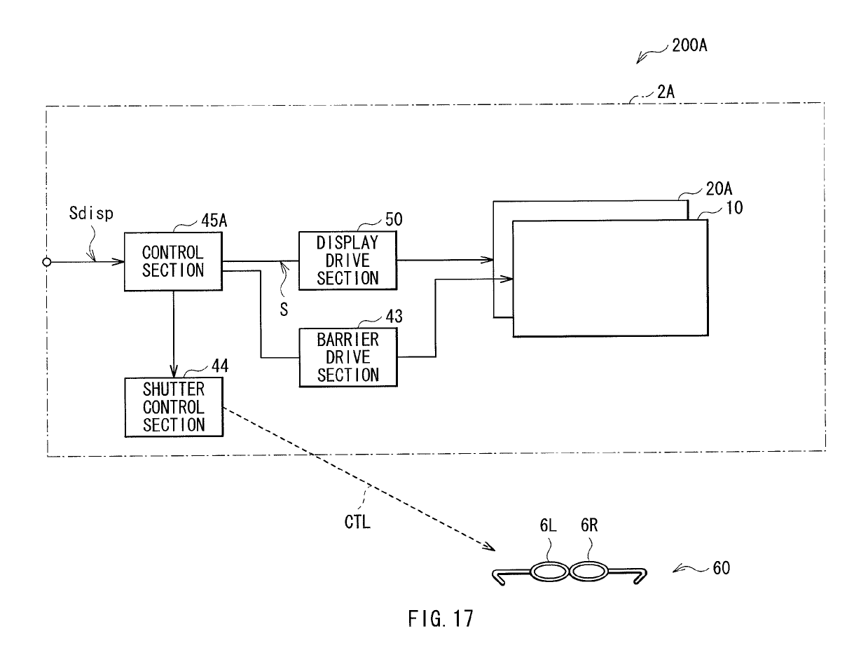

FIG. 17 illustrates an exemplary configuration of a display system 200A according to this modification. The display system 200A includes a display device 2A. The display device 2A includes a display section 20A and a control section 45A.

The display section 20A is configured of a self-luminous display element such as, but not limited to, a plasma display device. The control section 45A controls a display drive section 50, a barrier drive section 43, and a shutter control section 44 based on an externally-supplied picture signal Sdisp. Specifically, since the display device 2A includes the display section 20A including the self-luminous display element, it does not have a backlight and a backlight drive section unlike the display device 2 according to the second embodiment described above.

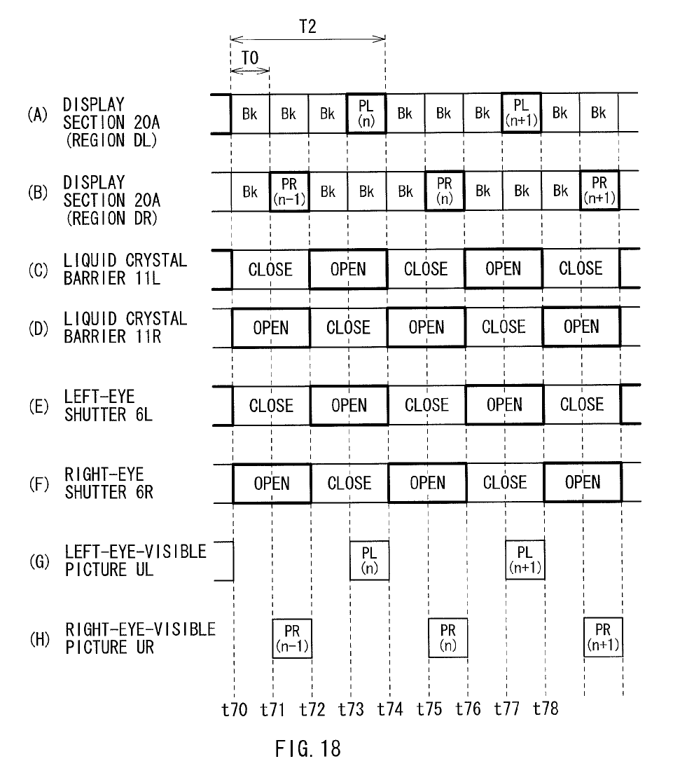

FIG. 18 illustrates an exemplary operation of the display system 200A, where (A) and (B) show operations of regions DL and DR of a display section 20A, respectively, (C) and (D) show operations of liquid crystal barriers 11L and 11R of a barrier section 10, respectively, (E) and (F) show operations of a left-eye shutter 6L and a right-eye shutter 6R of shutter glasses 60, respectively, and (G) and (H) show a left-eye-visible picture UL and a right-eye-visible picture UR perceived by a viewer, respectively.

In the display device 2A, during a period of timing t70 to timing t73, the display section 20A repeatedly displays a black image generated by the control section 45A on a region DL over a period corresponding to three frame periods T0, and during a subsequent period of timing t73 to timing t74, the display section 20 displays a left-eye image PL(n) on the region DL ((A) of FIG. 18). During a period of timing t72 to timing t74, the liquid crystal barrier 11L and the left-eye shutter 6L are opened (light-transmitting state) ((C) and (E) of FIG. 18). A viewer thus sees the left-eye image PL(n) during the period of timing t73 to timing t74 ((G) of FIG. 18).

Similarly, in the display device 2A, during a period of timing t72 to timing t75, the display section 20A repeatedly displays the black image generated by the control section 45A on a region DR over a period corresponding to three frame periods T0, and during a subsequent period of timing t75 to timing t76, the display section 20A displays a right-eye image PR(n) on the region DR ((B) of FIG. 18). During a period of timing t74 to timing t76, the liquid crystal barrier 11R and the right-eye shutter 6R are opened (light-transmitting state) ((D) and (F) of FIG. 18). A viewer thus sees the right-eye image PR(n) during the period of timing t75 to timing t76 ((H) of FIG. 18).

In such a case, the same advantages as in the display system 200 according to the second embodiment are also provided.

### [Modification 2-3]

While the display device 2 is a quadruple-speed liquid crystal display device in the second embodiment, this is not limitative. For example, the display device 2 may be a 2× or 6× display device as in the modification 1-1.

### 3. Third Embodiment

A display system 300 according to a third embodiment is now described. The display system 300 according to the third embodiment is provided through applying the display system 100 according to the first embodiment to a multi-view system that enables a plurality of viewers to see different pictures at the same time. It is to be noted that substantially the same components as those of the display system 100 according to the first embodiment are designated by the same numerals, and description of them is appropriately omitted. An exemplary multi-view system where two viewers see two different pictures at a time is now described.

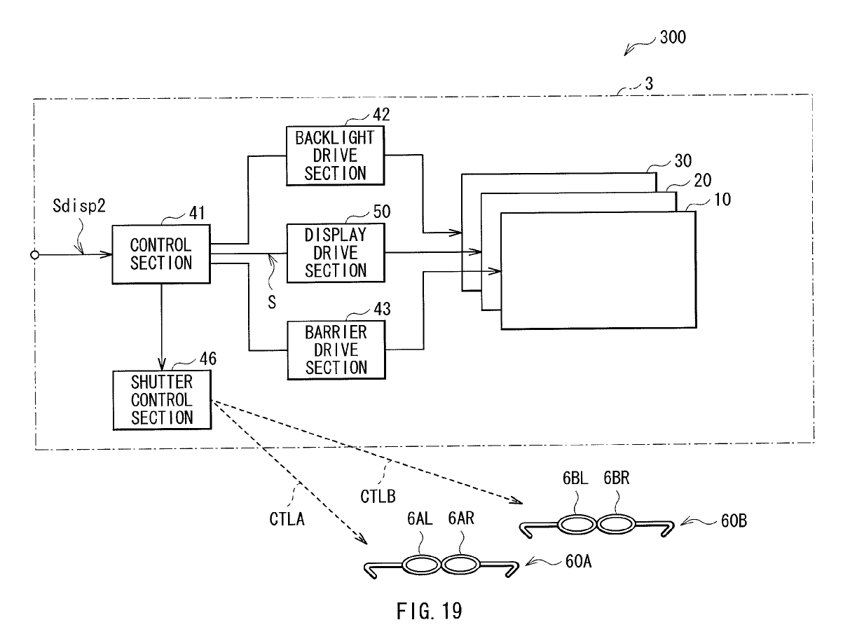

FIG. 19 illustrates an exemplary configuration of a display system 300 according to the third embodiment. The display system 300 includes a display device 3 and two shutter glasses 60A and 60B. The display device 3 displays images PA for a viewer 9A and images PB for a viewer 9B based on a picture signal Sdisp2. The picture signal Sdisp2 contains image information of each of the images PA and PB. The shutter glasses 60A and 60B are worn by the viewers 9A and 9B.

The display device 3 includes a shutter control section 46. The shutter control section 46 generates two shutter control signals CTLA and CTLB, and supplies the shutter control signal CTLA to the shutter glasses 60A, and supplies the shutter control signal CTLB to the shutter glasses 60B. The shutter glasses 60A have a left-eye shutter 6AL and a right-eye shutter 6AR that are opened or closed based on the shutter control signal CTLA. In this operation, the left-eye shutter 6AL and the right-eye shutter 6AR are simultaneously opened or closed. Similarly, the shutter glasses 60B have a left-eye shutter 6BL and a right-eye shutter 6BR that are opened or closed based on the shutter control signal CTLB. In this operation, the left-eye shutter 6BL and the right-eye shutter 6BR are simultaneously opened or closed.

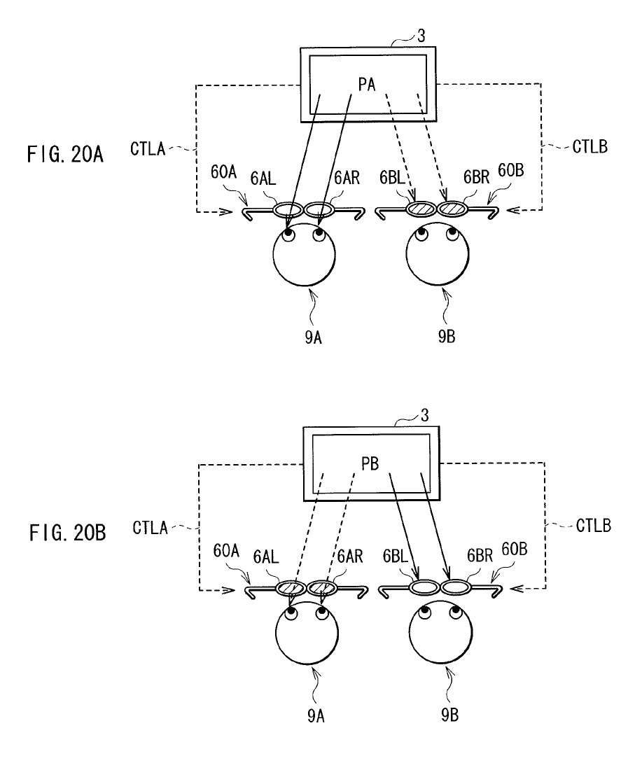

FIGS. 20A and 20B schematically illustrate general operation of the display system 300. FIG. 20A shows an operation during display of an image PA for a viewer 9A. FIG. 20B shows an operation during display of an image PB for a viewer 9B. During display of the image PA by the display device 3, as shown in FIG. 20A, the left-eye shutter 6AL and the right-eye shutter 6AR of the shutter glasses 60A are opened, while the left-eye shutter 6BL and the right-eye shutter 6BR of the shutter glasses 60B are closed. During this operation, a viewer 9A sees the image PA. On the other hand, during display of the image PB by the display device 3, as shown in FIG. 20B, the left-eye shutter 6AL and the right-eye shutter 6AR of the shutter glasses 60A are closed, while the left-eye shutter 6BL and the right-eye shutter 6BR of the shutter glasses 60B are opened. During this operation, a viewer 9B sees the image PB. These operations are alternately repeated, so that the viewer 9A sees a picture including the image PA, and the viewer 9B sees a picture including the image PB, thereby achieving a multi-view system in which respective viewers see pictures appearing on one display device.

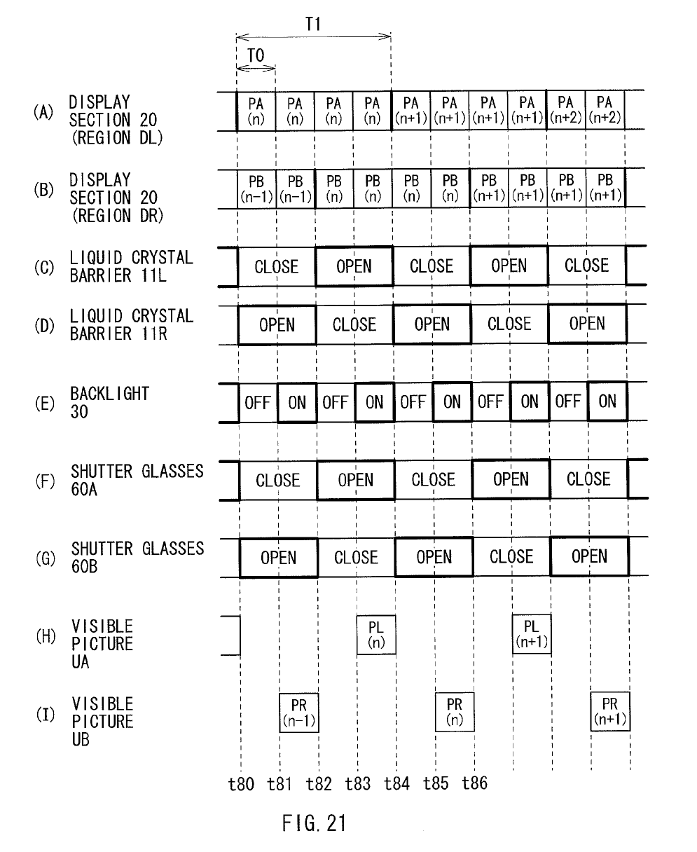

FIG. 21 illustrates an exemplary operation of the display system 300, where (A) and (B) show operations of regions DL and DR of a display section 20, respectively, (C) and (D) show operations of liquid crystal barriers 11L and 11R of a barrier section 10, respectively, (E) shows an operation of a backlight 30, (F) and (G) show operations of shutter glasses 60A and 60B, respectively, and (H) and (I) show a left-eye-visible picture UA perceived by the viewer 9A and a right-eye-visible picture UR perceived by the viewer 9B, respectively. In (A) and (B) of FIG. 21, a symbol PA indicates a state where the display section 20 displays the image PA, and a symbol PB indicates a state where the display section 20 displays the image PB.

In the display device 3, during a period of timing t80 to timing t84, the display section 20 repeatedly displays the same image PA(n) on a region DL over a period corresponding to four frame periods T0 (repetitive-display period T1) ((A) of FIG. 21). During a period of timing t82 to timing t84, the liquid crystal barrier 11L is opened (light-transmitting state), and during a period of timing t83 to timing t84, the backlight 30 is on ((C) and (E) of FIG. 21). Consequently, the display device 3 displays the image PA(n) during the period of timing t83 to timing t84. On the other hand, in the shutter glasses 60A, the left-eye shutter 6AL and the right-eye shutter 6AR are opened (light-transmitting state) during the period of timing t82 to timing t84 ((F) of FIG. 21). Consequently, a viewer sees the image PA(n) during the period of timing t83 to timing t84 ((H) of FIG. 21).

Similarly, in the display device 3, during a period of timing t82 to timing t86, the display section 20 repeatedly displays the same image PB(n) on a region DR over a period corresponding to four frame periods T0 (repetitive-display period T1) ((B) of FIG. 21). During a period of timing t84 to timing t86, the liquid crystal barrier 11R is opened (light-transmitting state), and during a period of timing t85 to timing t86, the backlight 30 is on ((D) and (E) of FIG. 21). Consequently, the display device 3 displays the image PB(n) during the period of timing t85 to timing t86. On the other hand, in the shutter glasses 60B, the left-eye shutter 6BL and the right-eye shutter 6BR are opened (light-transmitting state) during the period of timing t84 to timing t86 ((G) of FIG. 21). Consequently, a viewer sees the image PB(n) during the period of timing t85 to timing t86 ((I) of FIG. 21).

The above operation is repeated, thereby the viewer 9A perceives a picture UA through viewing the sequential images PA ((H) of FIG. 21), and the viewer 9B concurrently perceives a picture UB through viewing the sequential images PB ((I) of FIG. 21).

As described above, in the third embodiment, a plurality of shutter glasses are provided, the images PA and PB are displayed, and the left-eye shutter 6AL and the right-eye shutter 6AR are simultaneously opened or closed, thereby achieving the multi-view system. Other advantages are the same as in the first embodiment.

### [Modification 3-1]

While the display system 100 is applied to the multi-view system in the third embodiment, this is not limitative. Alternatively, for example, the display system 200 may be applied to the multi-view system.

While the present technology has been described with the several embodiments and modifications hereinbefore, the technology is not limited to the embodiments and others, and various modifications or alterations of the embodiments may be made.

For example, while the regions DL and DR are provided in the display section 20, and the liquid crystal barriers 11L and 11R are provided at positions corresponding to the regions DL and DR in the embodiments, the number of the regions and of the liquid crystal barriers may be increased without limitation. The following focuses on application of such a modification to the display system 100 according to the first embodiment.

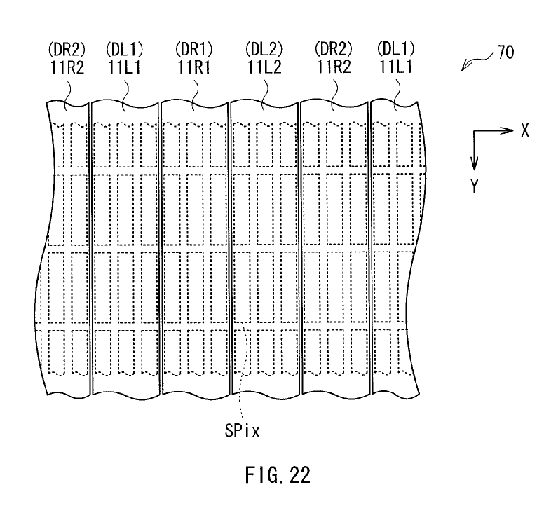

FIG. 22 illustrates a correspondence between liquid crystal barriers of a barrier section 70 according to the present modification and an arrangement of pixels Pix of a display section 20. As shown in FIG. 22, the barrier section includes liquid crystal barriers 11L1, 11R1, 11L2, and 11R2. The liquid crystal barriers 11L1, 11R1, 11L2, and 11R2 are provided to extend in a vertical direction Y, and arranged cyclically in this order in a horizontal direction X. The display section 20 has regions DL1, DR1, DL2, and DR2 at positions corresponding to the liquid crystal barriers 11L1, 11R1, 11L2, and 11R2, respectively. The display section 20 displays left-eye images PL in the regions DL1 and DL2, and displays the right-eye images PR in the regions DR1 and DR2.

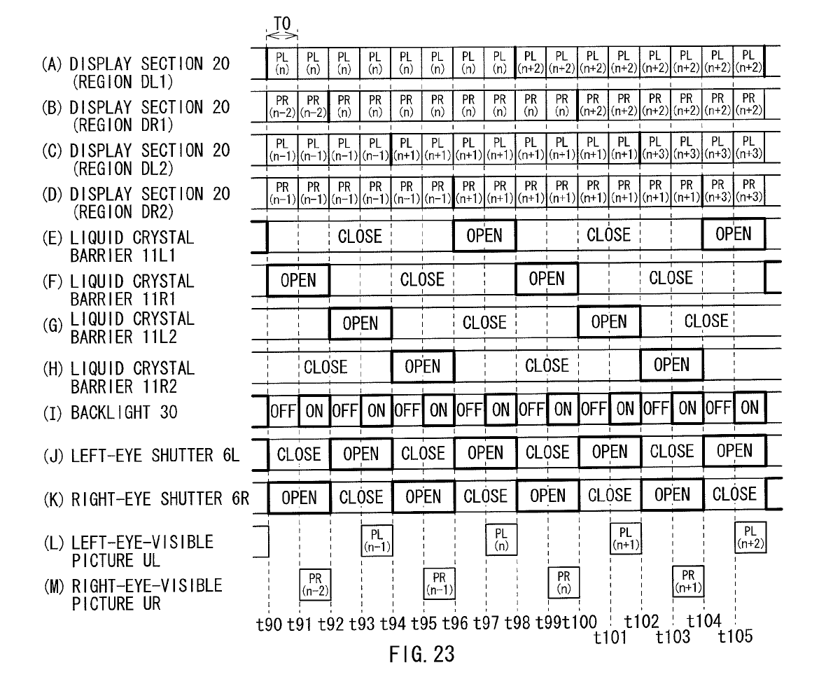

FIG. 23 illustrates an exemplary operation of the display system according to the present modification, where (A) to (D) show operations of the regions DL1, DR1, DL2, and DR2, respectively, (E) to (H) show operations of the liquid crystal barriers 11L1, 11R1, 11L2, and 11R2 of the barrier section 10, respectively, (I) shows an operation of the backlight 30, (J) and (K) show operations of the left-eye shutter 6L and the right-eye shutter 6R, respectively, and (L) and (M) show a left-eye-visible picture UL and a right-eye-visible picture UR perceived by a viewer, respectively.

In the display device 1, during a period of timing t90 to timing t98, the display section 20 repeatedly displays the same left-eye image PL(n) on a region DL1 over a period corresponding to eight frame periods T0 ((A) of FIG. 23). The frame period T0 is 4.2 msec (=1/4/60 Hz). Specifically, the display device 1 is a so-called quadruple-speed, liquid crystal display device herein. During a period of timing t96 to timing t98, the liquid crystal barrier 11L1 is opened (light-transmitting state), and during a period of timing t97 to timing t98, the backlight 30 is on ((E) and (I) of FIG. 23). Consequently, the display device 1 displays the left-eye image PL(n) during the period of timing t97 to timing t98. On the other hand, in the shutter glasses 60, the left-eye shutter 6L is opened (light-transmitting state) during the period of timing t96 to timing t98 ((J) of FIG. 23). Consequently, a viewer sees the left-eye image PL(n) during the period of timing t97 to timing t98 ((L) of FIG. 23).

Similarly, in the display device 1, during a period of timing t92 to timing t100, the display section 20 repeatedly displays the same right-eye image PR(n) on a region DR1 over a period corresponding to eight frame periods T0 ((B) of FIG. 23). During a period of timing t98 to timing t100, the liquid crystal barrier 11R1 is opened (light-transmitting state), and during a period of timing t99 to timing t100, the backlight 30 is on ((F) and (I) of FIG. 23). Consequently, the display device 1 displays the right-eye image PR(n) during the period of timing t99 to timing t100. On the other hand, in the shutter glasses 60, the right-eye shutter 6R is opened (light-transmitting state) during the period of timing t98 to timing t100 ((K) of FIG. 23). Consequently, the viewer sees the right-eye image PR(n) during the period of timing t99 to timing t100 ((M) of FIG. 23).

Similarly, in the display device 1, during a period of timing t94 to timing t102, the display section 20 repeatedly displays the same left-eye image PL(n+1) on a region DL2 over a period corresponding to eight frame periods T0 ((C) of FIG. 23). During a period of timing t100 to timing t102, the liquid crystal barrier 11L2 is opened (light-transmitting state), and during a period of timing t101 to timing t102, the backlight 30 is on ((G) and (I) of FIG. 23). Consequently, the display device 1 displays the left-eye image PL(n+1) during the period of timing t101 to timing t102. On the other hand, in the shutter glasses 60, the left-eye shutter 6L is opened (light-transmitting state) during the period of timing t100 to timing t102 ((J) of FIG. 23). Consequently, the viewer sees the left-eye image PL(n+1) during the period of timing t101 to timing t102 ((L) of FIG. 23).

Similarly, in the display device 1, during a period of timing t96 to timing t104, the display section 20 repeatedly displays the same right-eye image PR(n+1) on a region DR2 over a period corresponding to eight frame periods T0 ((D) of FIG. 23). During a period of timing t102 to timing t104, the liquid crystal barrier 11R2 is opened (light-transmitting state), and during a period of timing t103 to timing t104, the backlight 30 is on ((H) and (I) of FIG. 23). Consequently, the display device 1 displays the right-eye image PR(n+1) during the period of timing t103 to timing t104. On the other hand, in the shutter glasses 60, the right-eye shutter 6R is opened (light-transmitting state) during the period of timing t102 to timing t104 ((K) of FIG. 23). Consequently, the viewer sees the right-eye image PR(n+1) during the period of timing t103 to timing t104 ((M) of FIG. 23).

The above operation is repeated, thereby the viewer perceives a left-eye-visible picture UL through viewing sequential left-eye images PL ((L) of FIG. 23), and perceives a right-eye-visible picture UR through viewing the sequential right-eye images PR ((M) of FIG. 23), so that the viewer perceives a stereoscopic picture through viewing a picture appearing on the display system according to the present modification.

In this way, the number of the regions and the number of the liquid crystal barriers are increased, which further prolongs the period (repetitive-display period T1) where the same left-eye image PL and the same right-eye image PR are repeatedly displayed. As a result, a viewer sees an image after the response of the liquid crystal element LC is saturated, suppressing a degradation in image quality.

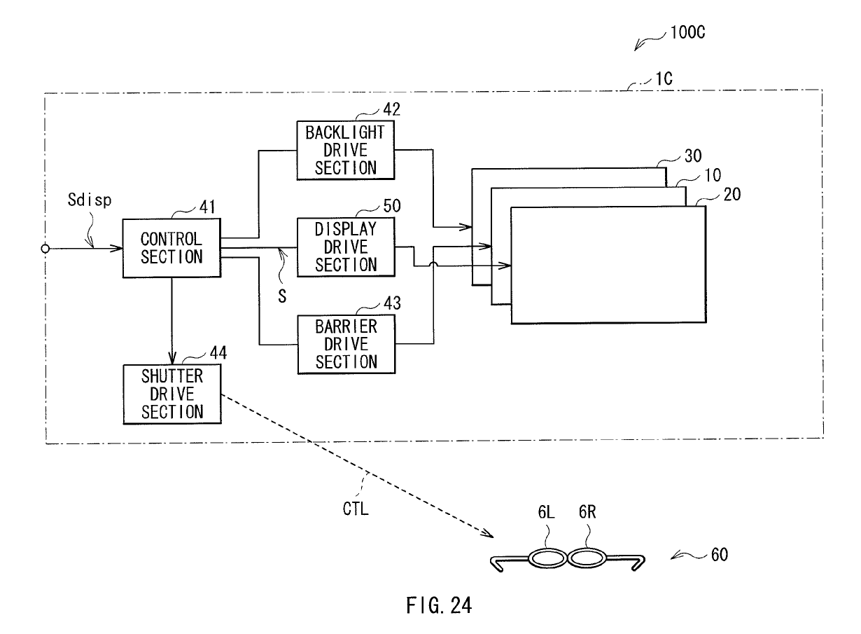

In addition, for example, while the backlight 30, the display section 20, and the barrier section 10 are disposed in this order in the embodiments, this is not limitative. Alternatively, for example, as shown in FIG. 24, the backlight 30, the barrier section 10, and the display section 20 may be disposed in this order.

Thus, it is possible to achieve at least the following configurations from the above-described example embodiments and the modifications of the disclosure.

(1) A display device, including:

a display section;

a barrier section including a plurality of light barriers, each of the light barriers being switched to be opened or closed; and

a shutter control section switching each of a left-eye shutter and a right-eye shutter of one or more shutter glasses to be opened or closed, in synchronization with timing of opening or closing of the light barriers.

(2) The display device according to (1),

wherein the light barriers are divided into a plurality of barrier groups, the barrier groups being switched to be opened or closed at timing points different from one another, and

the display section is divided, corresponding to the barrier groups, into a plurality of sub-regions displaying pictures different from one another.

(3) The display device according to (2), further including a barrier drive section driving the barrier section,

wherein the display section repeatedly displays each of frame images that form the picture on each of the sub-regions, over a repetitive-display period including a predetermined number of frame periods, and

the barrier drive section allows the light barriers belonging to a first barrier group in the plurality of barrier groups to be opened, only in a first period in the repetitive-display period corresponding to the first barrier group, and allows the light barriers belonging to a second barrier group in the plurality of barrier groups to be opened, only in a second period in the repetitive-display period corresponding to the second barrier group, the second period being different from the first period.

(4) The display device according to (3), wherein the first period and the second period each reside as a frame period other than a leading frame period in the repetitive-display period.

(5) The display device according to (2), further including a barrier drive section driving the barrier section,

wherein the display section time-divisionally displays each of frame images and a black image on each of the sub-regions, to allow the frame images to be displayed in periods different from one another between the sub-regions, the frame images forming a picture, and

the barrier drive section allows the light barriers belonging to each of the barrier groups to be opened, only in a first period corresponding to a period during which the frame image is displayed on the sub-regions that correspond to the light barriers belonging to each of the barrier groups.

(6) The display device according to any one of (2) to (5),

wherein the light barriers are divided into a first barrier group and a second barrier group,

the display section displays a left-eye picture on the sub-regions corresponding to the first barrier group, and displays a right-eye picture on the sub-regions corresponding the second barrier group, and

the shutter control section allows the left-eye shutter to be opened, only in a period corresponding to a period during which the light barriers belonging to the first barrier group are opened, and allows the right-eye shutter to be opened, only in a period corresponding to a period during which the light barriers belonging to the second barrier group are opened.

(7) The display device according to any one of (2) to (5), wherein the shutter control section allows both the left-eye shutter and the right-eye shutter of predetermined shutter glasses of the one or more shutter glasses to be opened, only in a period corresponding to a period during which the light barriers belonging to each of the barrier groups are opened.

(8) The display device according to any one of (1) to (7), further including a backlight emitting light in a period corresponding to a period during which the light barriers are opened,

wherein the display section includes a liquid crystal display element modulating the light from the backlight.

(9) The display device according to (8), wherein the display section is provided between the backlight and the barrier section.

(10) The display device according to (8), wherein the barrier section is provided between the backlight and the display section.

(11) The display device according to (5), wherein the display section includes a self-luminous display element.

(12) A displaying method, including:

displaying a picture;

switching a plurality of light barriers to be opened or closed; and

switching each of a left-eye shutter and a right-eye shutter of one or more shutter glasses to be opened or closed, in synchronization with timing of opening or closing of the light barriers.

The present disclosure contains subject matter related to that disclosed in Japanese Priority Patent Application JP 2011-118189 filed in the Japan Patent Office on May 26, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a display section;
a barrier section including a plurality of light barriers, each of the light barriers being switched to be opened or closed; and
a shutter control section switching each of a left-eye shutter and a right-eye shutter of one or more shutter glasses to be opened or closed, in synchronization with timing of opening or closing of the light barriers.

2. The display device according to claim 1,
wherein the light barriers are divided into a plurality of barrier groups, the barrier groups being switched to be opened or closed at timing points different from one another, and
the display section is divided, corresponding to the barrier groups, into a plurality of sub-regions displaying pictures different from one another.

3. The display device according to claim 2, further comprising a barrier drive section driving the barrier section,
wherein the display section repeatedly displays each of frame images that form the picture on each of the sub-regions, over a repetitive-display period including a predetermined number of frame periods, and
the barrier drive section allows the light barriers belonging to a first barrier group in the plurality of barrier groups to be opened, only in a first period in the repetitive-display period corresponding to the first barrier group, and allows the light barriers belonging to a second barrier group in the plurality of barrier groups to be opened, only in a second period in the repetitive-display period corresponding to the second barrier group, the second period being different from the first period.

4. The display device according to claim 3, wherein the first period and the second period each reside as a frame period other than a leading frame period in the repetitive-display period.

5. The display device according to claim 2, further comprising a barrier drive section driving the barrier section,
wherein the display section time-divisionally displays each of frame images and a black image on each of the sub-regions, to allow the frame images to be displayed in periods different from one another between the sub-regions, the frame images forming a picture, and
the barrier drive section allows the light barriers belonging to each of the barrier groups to be opened, only in a first period corresponding to a period during which the frame image is displayed on the sub-regions that correspond to the light barriers belonging to each of the barrier groups.

6. The display device according to claim 2,
wherein the light barriers are divided into a first barrier group and a second barrier group,
the display section displays a left-eye picture on the sub-regions corresponding to the first barrier group, and displays a right-eye picture on the sub-regions corresponding the second barrier group, and
the shutter control section allows the left-eye shutter to be opened, only in a period corresponding to a period during which the light barriers belonging to the first barrier group are opened, and allows the right-eye shutter to be opened, only in a period corresponding to a period during which the light barriers belonging to the second barrier group are opened.

7. The display device according to claim 2, wherein the shutter control section allows both the left-eye shutter and the right-eye shutter of predetermined shutter glasses of the one or more shutter glasses to be opened, only in a period corresponding to a period during which the light barriers belonging to each of the barrier groups are opened.

8. The display device according to claim 1, further comprising a backlight emitting light in a period corresponding to a period during which the light barriers are opened,
wherein the display section includes a liquid crystal display element modulating the light from the backlight.

9. The display device according to claim 8, wherein the display section is provided between the backlight and the barrier section.

10. The display device according to claim 8, wherein the barrier section is provided between the backlight and the display section.

11. The display device according to claim 5, wherein the display section includes a self-luminous display element.

12. A displaying method, comprising:
displaying a picture;
switching a plurality of light barriers to be opened or closed; and
switching each of a left-eye shutter and a right-eye shutter of one or more shutter glasses to be opened or closed, in synchronization with timing of opening or closing of the light barriers.
